(19) United States
(12) Patent Application Publication
(10) Pub. No.: US 2014/0091510 A1
(43) Pub. Date: Apr. 3, 2014

(54) FASTENING HARDWARE HOLDER WITH INSTALLATION INDICATOR

(71) Applicant: LLOYD, GERSTNER & PARTNERS, Paramus, NJ (US)

(72) Inventors: Robert GERSTNER, New York, NY (US); Robert Christopher KIDD, New York, NY (US)

(73) Assignee: Lloyd, Gerstner & Partners, Paramus, NJ (US)

(21) Appl. No.: 13/632,526

(22) Filed: Oct. 1, 2012

(51) Int. Cl. B25B 1/20

(52) U.S. Cl. 269/41

(57) ABSTRACT

An apparatus for holding fastening hardware in place on a workpiece having an arrangement of through-holes. The apparatus includes a body having a first surface and a second surface on opposite sides of the body. The first surface has at least one projection extending from the first surface and a recess configured to hold the fastening hardware, with the recess being open to the first surface. A brace extends from the second surface of the body and is configured to hold the first surface in an installation position relative to the workpiece. The at least one projection is inserted in a first hole of the arrangement of through-holes when the first surface is in the installation position. The fastening hardware is held by the recess in a position to receive a complementary fastener through a second hole of the arrangement of through-holes when the first surface is in the installation position.

### BACKGROUND OF THE INVENTION

1. Field of the Invention

The present invention relates to a fastening hardware holder. More specifically, the present invention relates to a device for holding fastening hardware in place for receiving a complementary fastener, the device also providing a visual indication that qualified hardware has been used.

2. Description of the Related Art

Pallet racking is widely used in warehouses, distribution hubs, and some large retail stores. As shown in FIG. 1, typical pallet racking includes upright frames having columns 12 and cross bars 14, with beams 16 connected between the frames. FIG. 2 shows an example of a C-shaped column 12 having a front 122 and opposing sides 124 and a rear 125. The front 122 has two vertically arranged series of holes 126 and the sides 124 have one vertically arranged series of holes 128. FIG. 2 also shows two examples of beam connections. Beam 16 has a connector that is a flange connected to a side 124 through one of the holes 128. Beam 16′ has a different connection in which the connector is an angle that faces the front and one side and connects to the front 122 through one of the holes 126.

When installing the pallet racks, and when moving beams in an existing rack, it is difficult for the installers to hold the nut in the interior of the column while threading the associated bolt through the beam connector and the column.

There are two known devices for holding a nut in place, namely clip nuts and cage nuts. An example of a clip nut is disclosed in U.S. Pat. No. 4,219,064. The clip nut includes a clip to hold the nut in place on a panel. However, this clip will not work easily for holding a nut on the interior of a column as depicted in FIG. 2 because of the holes are not near an edge of a panel.

An example of a cage nut is shown in U.S. Patent Application Publication No. 2011/0020091. The cage nut has two arms extending from the nut and through a hole on a panel or other component on which the nut is to be held. More specifically, the arms are held against the sides of the hole to hold the nut in place. This known cage nut assembly is difficult to place into the hole from the interior of the column in FIG. 2. Furthermore, once it is installed, there is no identifiable assurance that the correct equipment has been used.

### SUMMARY OF THE INVENTION

An object of the present invention is to provide a device that is configured to hold a fastener in place to receive a complementary fastener. Another object of the present invention is to provide an indication that qualified hardware has been used.

According to an embodiment of the present invention, an apparatus for holding a fastener, e.g., a nut, in a place in a workpiece, where the workpiece has an arrangement of throughholes, includes a body having a first surface with at least one projection projecting from the first surface and a recess in which the nut is held, the recess being open to the first surface. The apparatus further includes a brace configured to hold the first surface in an installation position relative to the workpiece. The at least one projection is inserted in a first hole of the arrangement of throughholes when the first surface is in the installation position, and the nut is disposed to receive a threaded fastener through a second hole of the arrangement of through holes when the first surface is in the installation position. The brace is configured to hold the first surface in the installation position by abutting another part of the workpiece.

In one embodiment of the present invention, the apparatus includes a handle facilitating manual insertion of the body into the installation position.

According to a further embodiment of the invention, the brace is detachable from the body such that the brace can be reused with another body.

The nut is injection molded into the body such that one side of the nut is flush to the first surface. The nut is a flange nut in a preferred embodiment of the invention. Alternatively, the nut could be any other type of nut or other female threaded part as required for the particular implementation of the present invention and may be held in the body by adhesives or any other known or hereafter developed connections.

According to yet another embodiment, the brace includes at least a resilient portion. The resilient portion is configured to produce a resilient force holding the projection in the first hole when the first surface is in the installation position. In a further embodiment, a second body with a second nut may be connected to the resilient brace member, such that the resilient brace member holds the body and the second body in two discrete installation positions.

The workpiece is a column of a shelving rack and the apparatus is configured to hold the nut on an interior surface of the column. The brace is offset from a center of the body so that two of the apparatuses can be mounted opposite each other in the same column at the same height. The projection is visible from outside of the column through the first hole so that verification of the correct hardware can be made without actual inspection of the hardware.

The workpiece includes a mounting surface and an abutting surface, the apparatus being configured so that the first surface faces the mounting surface and the brace abuts the abutting surface when the first surface of the body is in the installation position. The mounting surface and the abutting surface are opposing surfaces, whereby the first surface and the brace are configured for arrangement between the opposing surfaces. In one embodiment, the workpiece is a column and the mounting surface and abutting surface are interior surfaces of the column.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a perspective schematic diagram of a prior art shelving rack;

FIG. 2 is a perspective view of an attachment of beams to a column according to two examples of the prior art;

FIG. 3 is a perspective view of a rear and lateral side of a fastener-holding device according to an embodiment of the present invention in a dis-assembled state;

FIG. 4 is a perspective view of the rear and lateral side of the fastener-holding device of FIG. 3 in the assembled state;

FIG. 5 is a perspective view of the front and a lateral side of the fastener-holding device of FIG. 3;

FIG. 6 is a partially breakaway view the fastener-holding device of FIG. 3 installed in a column of a shelving rack;

FIGS. 7A-7C are views of another embodiment of the fastener-holding device installed in a column;

FIG. 8 is a schematic diagram showing two apparatuses arranged in one column;

FIG. 9 is a top view of a column showing yet another example of a fastening hardware-holding device being installed in the column;

FIG. 10 is a top view of a column showing the installed state of the embodiment of FIG. 9; and

FIG. 11 is a simplified perspective view of two columns and a beam of a rack indicating a feature of the present invention visible from outside of the column.

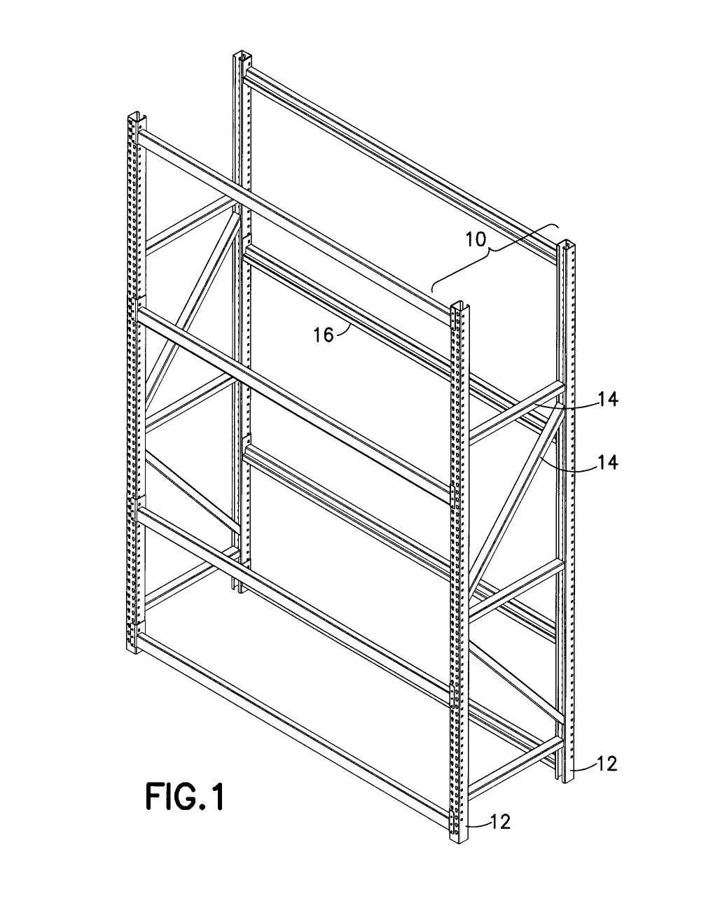

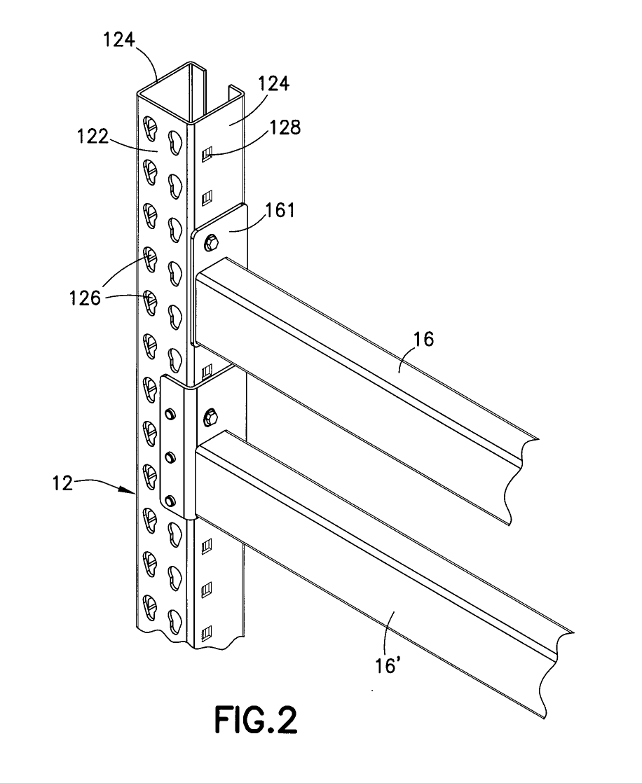

### DETAILED DESCRIPTION OF THE PREFERRED EMBODIMENTS

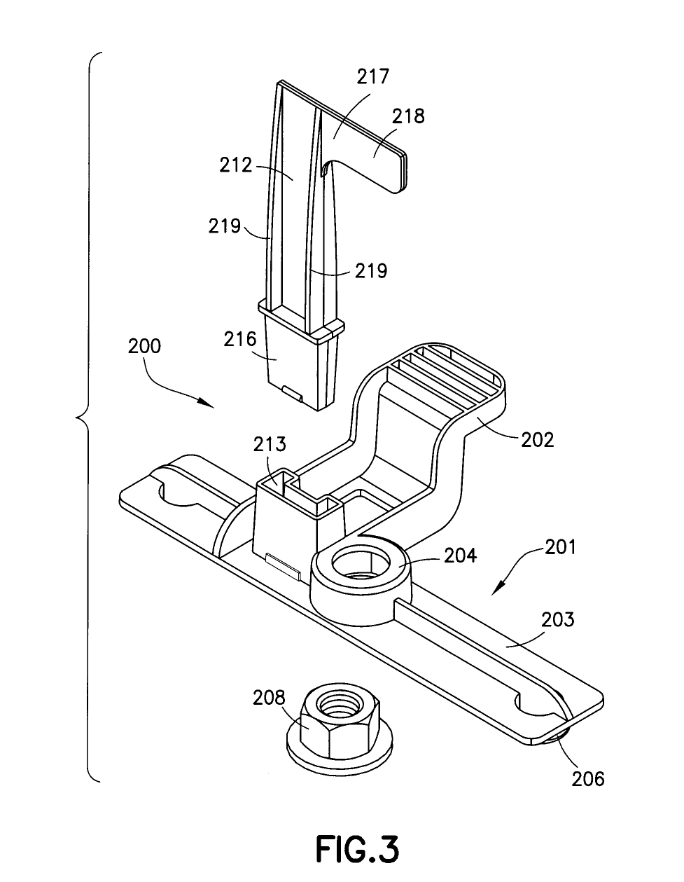

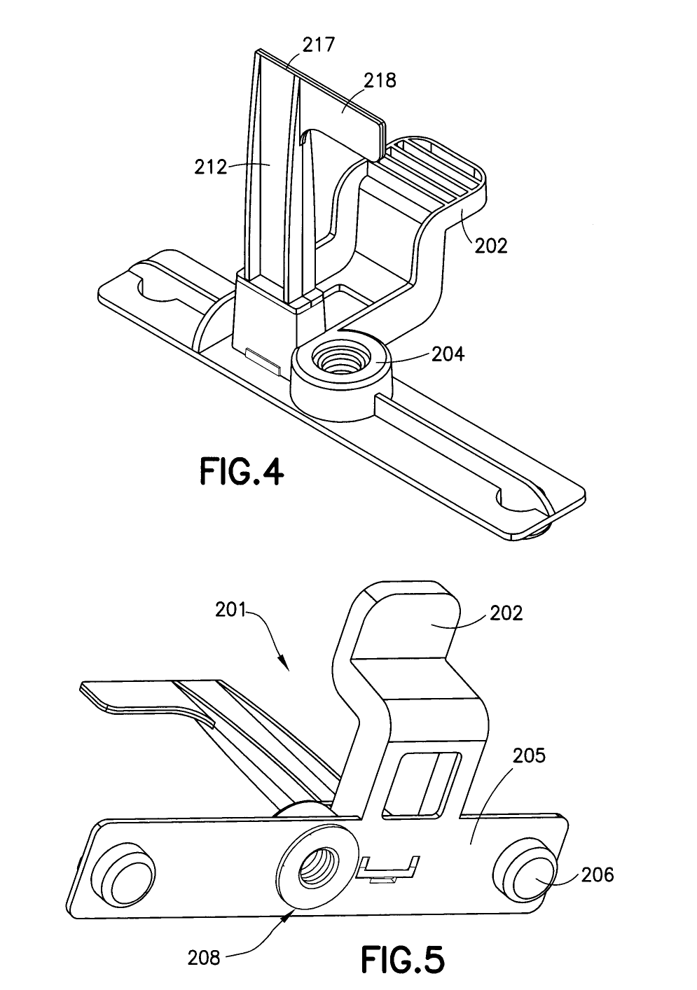

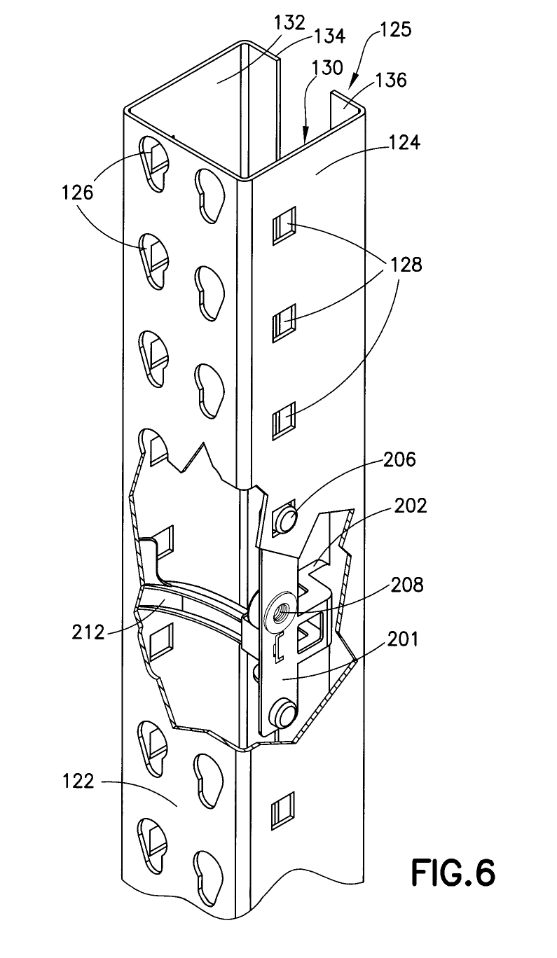

FIGS. 3-5 show a device 200 for holding a fastener, e.g., a nut, in place on a workpiece, where the workpiece has a pattern of regularly spaced holes on at least surface thereof. In particular, the workpiece is a column 12 (see FIG. 6) of a pallet rack or other shelving rack and includes a front 122, opposing sides 124 and a rear 125. The front surface 122 has two vertically arranged series of holes 126 and the side surfaces have one vertically arranged series of holes 128. The column also has at least two opposing interior surfaces 130, 132, as shown in FIG. 6, as will be described in more detail below. The particular column 12 is merely shown as an example and different patterns of holes cross-sectional shapes of the column are possible. In fact, each manufacturer of pallet racks has a different arrangement of holes and the device 200 can be adapted to each of these different arrangements. The column 12 shown in FIG. 6 is a C-shaped column having a C-shaped cross-section. However, the column may alternatively comprise a U-shaped cross section or any other cross-sectional shape having interior surfaces on which the device may be situated.

Referring back to FIGS. 3-5, the device 200 includes a longitudinal body 201 having a front side 205 and a rear side 203. The front side 205 has projections 206, e.g., two projections in this example, and a recess 204 for receiving fastening hardware, e.g., a nut 208. The projections 206 and the nut 208 held by the recess 204 are spaced apart so that they correspond to three holes 128 in the column 12. Although two projections 206 are shown in this preferred embodiment, the body 201 may alternatively have one or more than two projections. The nut 208 is a flanged nut with the flange facing the front side 205 of the body 210. However, any nut that meets the requirements of a desired application may be used. In one embodiment, the nut 208 is injection molded into the body 201. Instead of a nut, the bolt may be held by the body 201. Moreover, any hardware for fastening rack structures known or hereafter developed may be held in the body 201.

A handle 202 is connected to the body 201, which facilitates insertion of the device 200 into the column 12 or other workpiece. A brace 212 has a connected end 216 insertable through a receiving hole 213 in the rear side 203 of the body 201. The brace 212 is configured such that when the projections 206 are inserted in the holes 128 in one of the interior surfaces 130, a free end 217 of the brace 212 abuts the opposing interior side 132 to maintain the device 200 in position and ready to receive a bolt through the hole 128 corresponding to the nut 208. The brace 212 may comprise one or more ribs 219 extending from the connected end toward the free end to prevent flexing of the brace 212. To further improve the ability of the brace 212 to hold the device 200 in place, the free end 217 of the brace 212 may include a projection 218, which increases a length of the portion of the free end 217 that is intended to abut the opposing interior surface. The projection 218 preferably projects in a direction that is vertical with respect to the intended installation position of the device 200 in the column 12.

The fact that the brace 212 and body 201 are separate parts allows the brace to be removed after installation is complete and used for another body 201. In addition, the separate brace 212 allows different length braces 212 to be used with the same body 201. For example, if the bolt is intended to be received through holes 126 on the front 122 of the column 12, a shorter brace may be required between the front and rear of the column 12. Although the brace 212 and body 201 are disclosed as separate pieces, the brace 212 could alternatively be made as an integral part of the body 201.

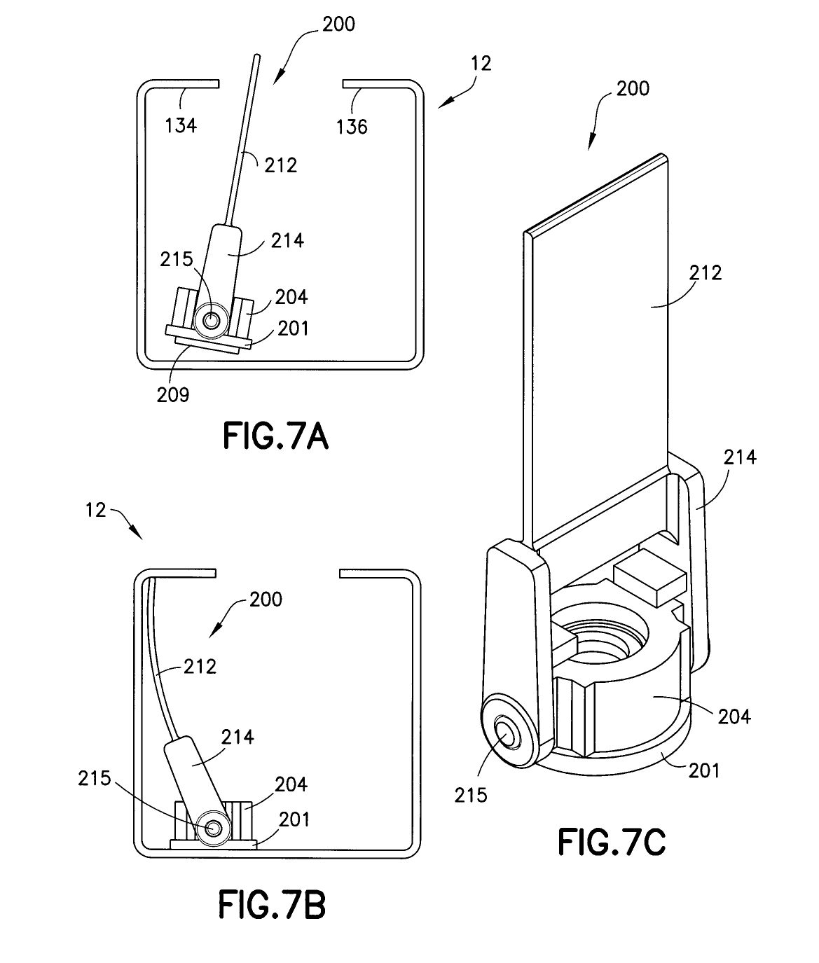

FIGS. 7A-7C show an alternative embodiment of the apparatus 200 in which the body 201 is primarily formed by the recessed portion 204 which holds the fastener, and there are no additional projections (as in FIG. 3, 206). In this embodiment, the body 201 may include a projection in the form of a flange 209 which extends into one of the through-holes of the workpiece to hold the body 201 in position. The brace 212 may have two base portions 214 which connect to the body 201 at joints 215 which allow pivoting of the brace 212. The configuration of the brace 212 may require a length offset between the connected end (at joint 215) and the free end of the brace 212 so that the free end firmly abuts the rear interior surfaces 134 or 136 on the rear of the column 12. The offset may be achieved, for example, by including a dogleg-shaped portion in the brace or by providing at least a resilient portion of the brace, as shown in FIG. 7. The pivoting brace 212 configuration shown in FIGS. 7A-7C may also be used with the body 201 of the embodiments of FIGS. 3-5 in lieu of having a non-pivoting brace 212 with a connected end 216 insertable through a receiving hole 213 in the rear side 203 of the body 201.

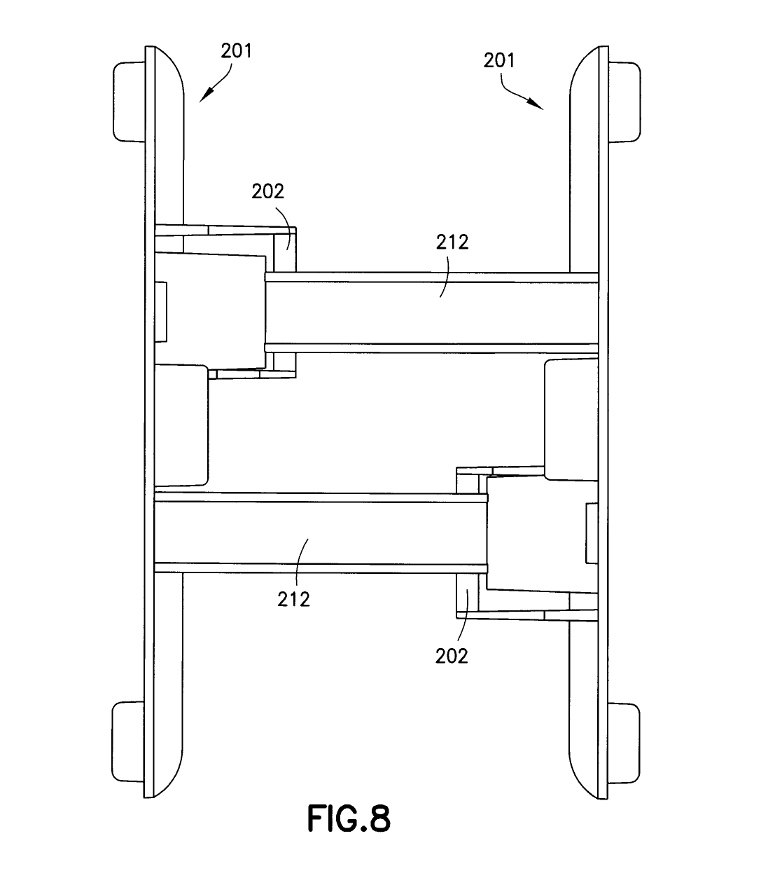

As shown in FIG. 8, the brace 212 may be arranged at a location on the body 201 such that the device 200 arranged on one interior surface 130 allows a second device 200 to be placed and held on the opposing surface 132 at the same level. This may be accomplished by arranging the braces 212 so that they are offset from a center of the longitudinal body 201 as depicted in FIG. 8. Here the braces 212 do not interfere with each other.

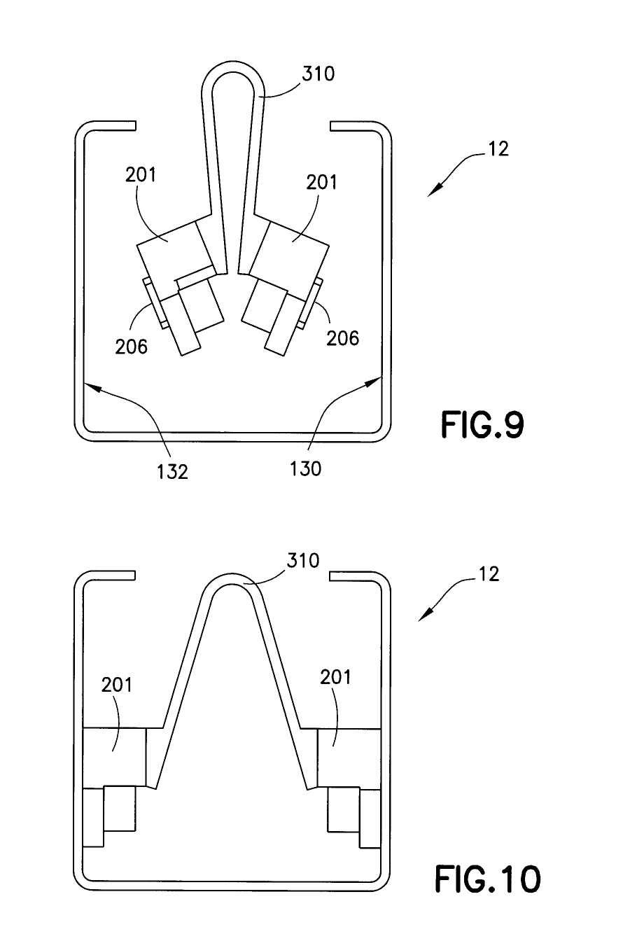

In a further embodiment shown in FIGS. 9-10, the brace is a resilient member 310, or has at least a resilient portion, arranged between two bodies 201 to resiliently press the bodies 201 against the opposing interior surfaces 130, 132 of the column 12. In FIG. 9, the resilient member 310 is squeezed or compressed so that the bodies 201 are insertable through the rear 125 of the column 12. In this embodiment, the member 310 simultaneously holds both bodies 201 in place and serves as a handle to facilitate positioning the bodies 201 into the column 12. When the bodies 201 are aligned with their respective holes, the resilient member 310 is released and both bodies 201 are held in an installation position for receiving a bolt. Instead of being attached to the two bodies, the resilient member 310 may be attached to only one body so that the free end of the resilient member abuts the opposing interior surface. Similarly to the brace 212, the resilient member 310 may be removed from the body 201 or bodies 201 after the device 200 is bolted in place.

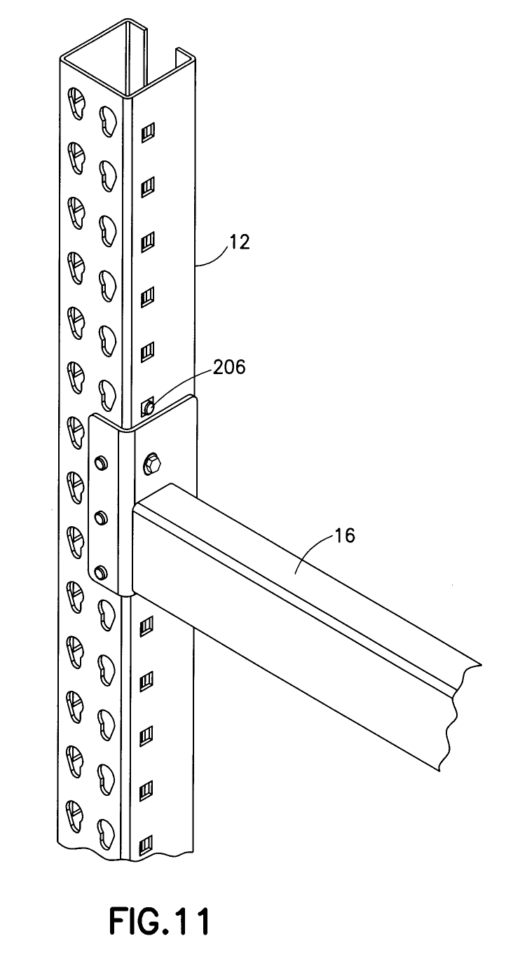

Once the bodies 201 are bolted in place in the column 12, at least one of the projections 206 is visible through the holes 128 in the column 12 to an observer outside of the column as indicated by an arrow in FIG. 11. Bodies of different colors may be used to indicate different sizes and or grades of components. Accordingly, if the bodies 201 are made with pre-qualified components, the use of qualified hardware can be confirmed visually from the exterior of the column by observing the projection 206.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus for holding fastening hardware in place on a workpiece having an arrangement of through-holes, the apparatus comprising:
a body having a first surface and a second surface on opposite sides of the body, the first surface having at least one projection extending from the first surface and a recess configured to hold the fastening hardware, the recess being open to the first surface; and
a brace extending from the second surface of the body and being configured to hold the first surface in an installation position relative to the workpiece, wherein the at least one projection is inserted in a first hole of the arrangement of through-holes when the first surface is in the installation position,
wherein the fastening hardware is held by the recess in a position to receive a complementary fastener through a second hole of the arrangement of through-holes when the first surface is in the installation position.

2. The apparatus of claim 1, wherein the brace is configured to hold the first surface in the installation position by abutting another part of the workpiece.

3. The apparatus of claim 1, further comprising a handle extending from the body to facilitate manual insertion of the body into the installation position.

4. The apparatus of claim 1, wherein the brace is detachable from the body such that the brace can be reused with another body.

5. The apparatus of claim 1, wherein the fastening hardware is injection molded into the body such that one side of the fastening hardware is flush with the first surface.

6. The apparatus of claim 1, wherein the fastening hardware is a flange nut.

7. The apparatus of claim 1, wherein the brace comprises at least a resilient portion.

8. The apparatus of claim 7, wherein the resilient portion is configured to produce a resilient force holding the projection in the first hole when the first surface is in the installation position.

9. The apparatus of claim 1, further comprising a second body with a second fastening hardware connected to the brace, such that the brace holds the body and the second body in two distinct installation positions.

10. The apparatus of claim 1, wherein the workpiece is a column of a shelving rack and the apparatus is configured to hold the fastening hardware on an interior surface of the column.

11. The apparatus of claim 10, wherein the brace is offset from a center of the body so that two of the apparatuses can be mounted opposite each other in a same column at a same height.

12. The apparatus of claim 10, wherein the projection is visible from outside of the column through the first hole.

13. The apparatus of claim 1, wherein the workpiece has a mounting surface and an opposing surface, the apparatus being configured so that the first surface faces the mounting surface and the brace abuts the opposing surface when the first surface of the body is in the installation position.

14. The apparatus of claim 13, wherein the workpiece is an elongate hollow member, and the mounting surface and the opposing surface are interior surfaces of the member.

15. An apparatus for holding fastening hardware in place on a workpiece having an arrangement of through-holes, the apparatus comprising:
a body having a first surface having at least one projection extending from the first surface and a recess configured to hold the fastening hardware, the recess being open to the first surface and the projection surrounding the recess; and
a brace extending from the body and being configured to hold the first surface in an installation position relative to the workpiece, wherein the at least one projection is inserted in a first hole of the arrangement of through-holes when the first surface is in the installation position,
wherein the fastening hardware is held by the recess in a position to receive a complementary fastener through the first hole of the arrangement of through-holes when the first surface is in the installation position.

16. The apparatus of claim 15, wherein the brace is connected to the body by a pivot joint.
